(19) United States
(12) Patent Application Publication
(10) Pub. No.: US 2014/0223506 A1
(43) Pub. Date: Aug. 7, 2014

(54) METHOD AND APPARATUS FOR DETERMINING BASE PCR IN MULTIPLE IMAGES FOR BROADCASTING SERVICE BASED ON MULTIPLE IMAGES

(71) Applicant: Electronics and Telecommunications Research Institute, Daejeon-si (KR)

(72) Inventors: Sang Woo Ahn, Daejeon (KR); Kwi Hoon Kim, Daejeon (KR); Jae Hwui Bae, Daejeon (KR)

(73) Assignee: ELECTRONICS AND TELECOMMUNICATION RESEARCH INSTITUTE, Daejeon-si (KR)

(21) Appl. No.: 14/088,427

(22) Filed: Nov. 24, 2013

(30) Foreign Application Priority Data
Feb. 1, 2013 (KR) 10-2013-0012044

(51) Int. Cl. H04N 21/43

(52) U.S. Cl. CPC H04N 21/4307
USPC 725/131

(57) ABSTRACT

There is disclosed a method of synchronizing a first image and a second image forming multiple images in broadcasting service based on the multiple images. The method includes receiving a stream regarding the first stream and a stream regarding the second stream through a plurality of channels, obtaining the first image and the second image by decoding the stream regarding the first stream and the stream regarding the second stream and obtaining a base Program Clock Reference (PCR) descriptor in at least one of the stream regarding the first stream and the stream regarding the second stream, selecting a base stream based on the base PCR descriptor and determining a base PCR based on the base PCR descriptor, and synchronizing the first image and the second image based on the base PCR.

Priority to Korean patent application number 10-2013-0012044 filed on Feb. 1, 2013, the entire disclosure of which is incorporated by reference herein, is claimed.

### BACKGROUND OF THE INVENTION

1. Field of the Invention

The present invention relates to broadcasting service and, more particularly, to a method and apparatus for determining a Program Clock Reference (PCR), that is, a reference for multiple images for broadcasting service based on the multiple images.

2. Discussion of the Related Art

The 3-Dimensional (3-D) industry has recently been activated due to the release of explosively increasing 3-D movies and 3-D TV products. The 3-D industry is expanded to all broadcasting fields including terrestrial waves, satellites, cables, Internet Protocol TV (IPTV), and Digital Multimedia Broadcasting (DMB). Furthermore, Ultra High Definition TV (UHDTV) broadcasting service is emerging with the help of the next-generation UHDTV and has been in the spotlight as technology for more realistic broadcasting service by providing sharper picture quality and a larger screen. Furthermore, panorama broadcasting that provides panorama images, along with UHDTV, constitutes the mainstay of the next generation realistic broadcasting.

A method for providing realistic broadcasting service based on multiple images, such as 3-D TV, UHDTV, and panorama broadcasting service, can be divided into a service providing method through a single channel and a service providing method through a plurality of channels. The service providing method through a single channel has convenience in providing service because multiple images are provided at the same time through one physical channel, but has a disadvantage in that picture quality is deteriorated because all multiple images need to be transmitted in one bandwidth. In contrast, the service providing method through a plurality of channels is more complicated than the service providing method through a single channel in providing service because multiple images are provided at the same time through two or more physical channels, but is advantageous in that it can support high picture quality because multiple images are transmitted in two or more channels, respectively. Here, the term ‘the plurality of channels’ includes 1) a broadcasting channel+a broadcasting channel, 2) a broadcasting channel+an Internet channel, and 3) a broadcasting channel+a mobile broadcasting channel. Furthermore, the term ‘broadcasting channel’ can include a channel that is served to all media, such as terrestrial waves, IPTV, cables, satellites, and DMB.

A method of providing 3-D TV, UHDTV, and panorama broadcasting service through a plurality of channels can be said to be a more suitable method than the service providing method through a single channel in providing high-quality realistic service because there is no possibility of a reduction in picture quality. However, the service providing method through a plurality of channels has a problem in that multiple images need to be synchronized with a reception terminal and outputted because the multiple images are transmitted and received through additional channels, but a detailed method for the synchronization has not yet been provided.

### SUMMARY OF THE INVENTION

An object of the present invention is to provide a method and apparatus for defining a base PCR in multiple images for the next-generation realistic broadcasting service.

Another object of the present invention is to provide a method and apparatus for defining a base PCR in multiple images for broadcasting service based on multiple images.

Yet another object of the present invention is to provide a method and apparatus for defining a base PCR in multiple images for 3-D TV, UHDTV, and panorama broadcasting service.

Further yet another object of the present invention is to select a base stream and a base PCR in order to synchronize multiple images at least one of which is included in each of a plurality of streams received through a plurality of channels.

Still yet another object of the present invention is to analyze a base PCR for a base stream and synchronize multiple images.

In accordance with an aspect of the present invention, there is provided a method of synchronizing a first image and a second image forming multiple images in broadcasting service based on the multiple images. The method includes receiving a stream regarding the first stream and a stream regarding the second stream through a plurality of channels, obtaining the first image and the second image by decoding the stream regarding the first stream and the stream regarding the second stream and obtaining a base PCR descriptor in at least one of the stream regarding the first stream and the stream regarding the second stream, selecting a base stream based on the base PCR descriptor and determining a base PCR based on the base PCR descriptor, and synchronizing the first image and the second image based on the base PCR.

In accordance with another aspect of the present invention, there is provided a method of transmitting a first image and a second image forming multiple images in broadcasting service based on the multiple images. The method includes a base PCR descriptor in at least one of a stream regarding the first stream and a stream regarding the second stream and sending the streams to a reception terminal. Here, the base PCR descriptor includes at least one of a descriptor_tag field indicative of a type of the descriptor, a descriptor_length field indicative of the length of the descriptor, a Base_transport_steam_id field indicative of an ID value of a transport stream to be referred to, a Base_program_number field indicative of a program to be referred to, and a Base_PCR_PID field indicative of a base time axis.

In accordance with yet another aspect of the present invention, there is provided an apparatus for determining a base PCR for synchronizing a first image and a second image forming multiple images in broadcasting service based on the multiple images. The apparatus includes an input unit for receiving a stream regarding the first stream and a stream regarding the second stream through a plurality of channels, a decoding unit for obtaining the first image and the second image by decoding the stream regarding the first stream and the stream regarding the second stream and obtaining a base PCR descriptor in at least one of the stream regarding the first stream and the stream regarding the second stream, a base stream detection unit for detecting a base stream based on the base PCR descriptor, a base PCR detection unit for determining a base PCR based on the base PCR descriptor, and a synchronization unit for synchronizing the first image and the second image based on the base PCR.

In accordance with further yet another aspect of the present invention, there is provided a transmission terminal for transmitting a first image and a second image forming multiple images in broadcasting service based on the multiple images. The transmission terminal includes a transmission unit for including a base PCR descriptor in at least one of a stream regarding the first stream and a stream regarding the second stream and sending the streams to a reception terminal. The transmission unit sends the base PCR descriptor comprising at least one of a descriptor_tag field indicative of a type of the descriptor, a descriptor_length field indicative of the length of the descriptor, a Base_transport_steam_id field indicative of an ID value of a transport stream to be referred to, a Base_program_number field indicative of a program to be referred to, and a Base_PCR_PID field indicative of a base time axis.

### BRIEF DESCRIPTION OF THE DRAWINGS

FIG. 1 is a flowchart illustrating a method of determining a base PCR in accordance with an embodiment of the present invention;

FIG. 2 shows a case where both first and second images are transmitted in one channel;

FIG. 3 shows synchronization requirements for a first image and a second image for realistic broadcasting service transmitted in a plurality of channels; and

FIG. 4 is a block diagram of the apparatus for determining a base PCR in multiple images for realistic broadcasting service in accordance with an embodiment of the present invention.

### DETAILED DESCRIPTION OF THE EMBODIMENTS

The following contents illustrate only a principle of the present invention. Although not being clearly described and shown in this specification, the contents can implement the principle of the present invention and can implement various devices included in the concept and range of the present invention. Furthermore, it should be understood that in principle, conditional terms and embodiments listed in this specification are obviously intended only for the purposes of making the concept of the present invention understood and the scope of the present invention is not restricted by the specially listed embodiments and states. It is also to be understood that all detailed descriptions listing specific embodiments in addition to the principle, aspects, and embodiments of the present invention are intended to include the structural and functional equivalents of the facts. Furthermore, it should be understood that the equivalents include equivalents to be developed in the future, that is, all devices invented to perform the same function by substituting some elements, in addition to known equivalents.

The objects, characteristics, and advantages will become more evident through the following detailed description in connection with the accompanying drawings. In describing the present invention, a detailed description of the known functions and constitutions will be omitted if it is deemed to make the gist of the present invention unnecessarily vague. Some exemplary embodiments according to the present invention are described in detail below with reference to the accompanying drawings. 3-D TV is described as an exemplary embodiment of the present invention, but it is evident that the present invention can also be applied to realistic broadcasting service based on multiple images, such as UHDTV and panorama broadcasting service.

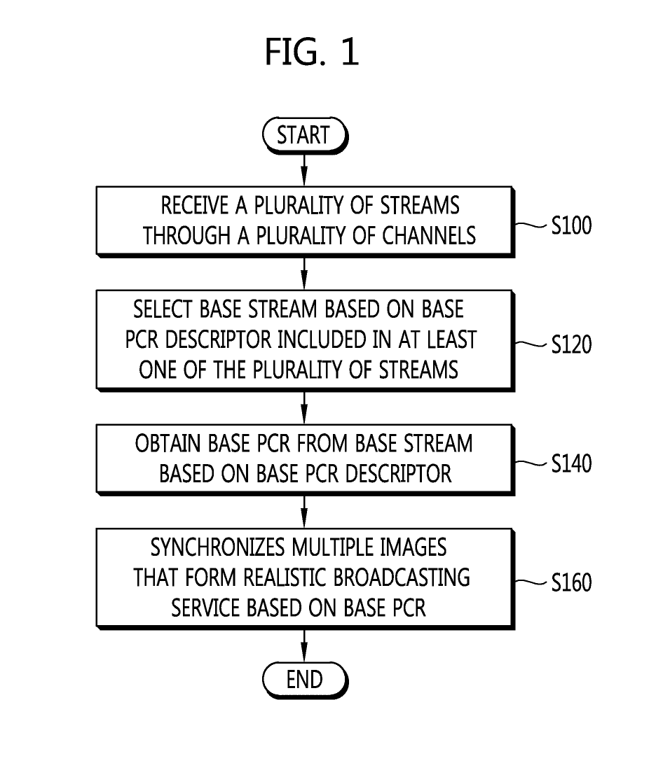

FIG. 1 is a flowchart illustrating a method of determining a base PCR in accordance with an embodiment of the present invention.

Referring to FIG. 1, an apparatus for determining a base PCR according to the present invention can be included a broadcasting receiver or a set-top box. Particularly, for example, the apparatus for determining a base PCR can be included a broadcasting receiver or a set-top box and can be included in a processor for synchronizing multiple images.

The apparatus for determining a base PCR can be supplied with realistic broadcasting service based on multiple images, such as 3-D TV, UHDTV, and panorama broadcasting service, through a plurality of channels.

The apparatus for determining a base PCR receives a plurality of streams through a plurality of channels at step S100. In order to provide realistic broadcasting service based on multiple images, each of the plurality of streams carries at least one image. At least one of the plurality of streams includes a base PCR descriptor to be described later.

In a Moving Picture Export Group (MPEG)-2 system, a Program Map Table (PMT) is included in a stream and transmitted. A major function of the PMT is to set a reference time for one broadcasting program and define the type of Elementary Stream (ES) forming a program and a unique number. The PMT is formed as follows.

TABLE 1

| SYNTAX | NUMBER OF BITS | FORMAT |
|---|---|---|
| TS_program_map_section( ){ | | |
| table_id | 8 | uimsbf(Unsigned Indicator, Most |
| | | Significant Bit First) |
| section_syntax_indicator | 1 | bslbf(Bit String, Left Bit First) |
| ‘0’ | 1 | bslbf |
| reserved | 2 | bslbf |
| section_length | 12 | uimsbf |
| program_number | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| reserved | 3 | bslbf |
| PCR_ID | 13 | uimsbf |
| reserved | 4 | bslbf |
| program_info_length | 12 | uimsbf |
| for(i=0;i<N;i++){ | | |
| descriptor( ) | | |
| } | | |
| for(i=0;i<N1;i++){ | | |
| stream_type | 8 | uimsbf |
| reserved | 3 | bslbf |
| elementary_PID | 13 | uimsbf |
| reserved | 4 | bslbf |
| ES_info_length | 12 | uimsbf |
| for(i=0;i<N2;i++){ | | |
| descriptor( ) | | |
| } | | |
| } | | |
| CRC_32 | 32 | rpchof(Remainder Plynomial |
| | | Coefficients, Highest Order First) |
| } | | |

Referring to Table 1, in the PMT, the program_number field defines a unique number for one broadcasting program, and the PCR_PID field defines a Packet Identifier (PID) value of an ES for sending a Program Clock Reference (PCR), that is, a reference time value for supporting synchronization between ESs forming a program.

The PMT includes a first descriptor loop and a second descriptor loop. The first descriptor loop includes information and a descriptor for each ES forming a program. Furthermore, the second descriptor loop defines the type of ES through the stream_type field and defines a unique number of an ES through the elementary_PID field.

In general, if both a first image (e.g., the left image of stereoscopic 3-D TV broadcasting service) and a second image (e.g., the right image of the stereoscopic 3-D TV broadcasting service) that form realistic broadcasting service are transmitted through one channel (i.e., independent channel), information about the first image and information about the second image are transmitted in the second descriptor loop of the PMT. Synchronization between the first image and the second image is performed by obtaining a PCR from the PCR_PID field.

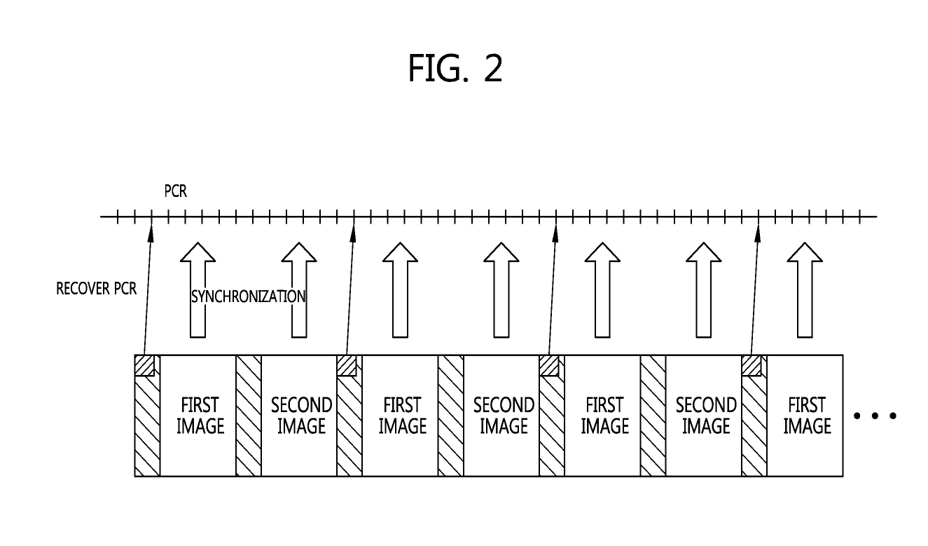

FIG. 2 shows a case where both first and second images are transmitted in one channel. FIG. 2 shows a case where a value of the PCR_PID field is set as the first image.

Referring to FIG. 2, an oblique part indicates a PCR value, and synchronization between the first image and the second image can be performed based on the PCR value set as the first image.

If a first image and a second image are transmitted through different channels (or a plurality of channels) or the second image is separately transmitted over an Internet network, however, there is a need for a definition regarding which one of the first image and the second image will be used as a base PCR in order for a reception terminal to synchronize the first image and the second image. A transmission terminal needs to give and send the definition. Here, the plurality of channels can mean physically different channels, physically the same channel, or logically different channels. Furthermore, the first image may be called a left image or a reference image, if necessary, and the second image may be called a right image or a supplementary image, if necessary.

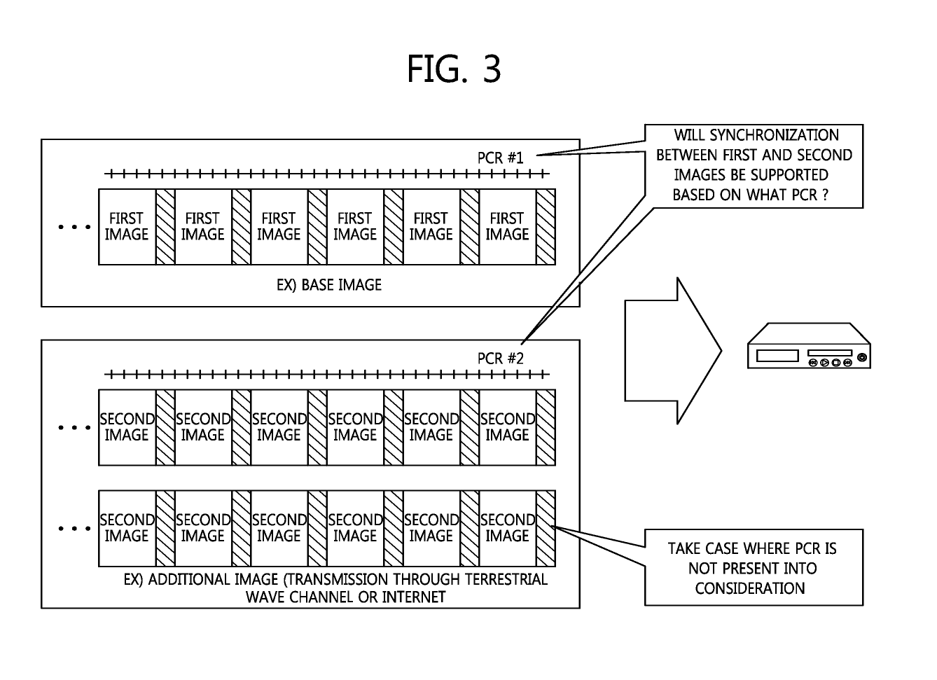

FIG. 3 shows synchronization requirements for a first image and a second image for realistic broadcasting service transmitted in a plurality of channels.

Referring to FIG. 3, if a PCR#1 is present in the first image and a PCR#2 is present in the second image, it is necessary to define that synchronization between the first image and the second image will be supported based on what PCR. Although the first image and the second image are transmitted through a plurality of channels, a PCR (e.g., a PCR#2) may be present in the second image. This corresponds to case where a PCR is not intentionally inserted into the second image when sending a Transport Stream (TS) regarding the second image. In this case, the MPEG-2 system is not satisfied, and there is a problem in that the output of a sole screen for the second image is difficult.

Accordingly, if the first image and the second image are separately transmitted through a plurality of channels, the following items need to be taken into consideration.

First, transport_stream_id in a Program Association Table (PAT) that carries information related to a program and the program_number field in the PMT in an MPEG-2 TS are used, wherein transport_stream_id and program_number regarding an image, that is, a reference, from among a first image and a second image, need to be included in at least one of a TS regarding the first image and a TS regarding the second image.

Second, if a PCR is present in each of a TS regarding the first image (hereinafter referred to as a ‘first image TS’) and a TS regarding the second image (hereinafter referred to as a ‘second image TS’) (i.e., a plurality of PCRs is present) or a PCR is present in any one of a first image TS and a second image TS, a value of PCR_PID, that is, a reference, needs to be set. For example, if the PCR of the first image is a reference for synchronization, a PCR_PID value of the first image needs to be set as a base PCR_PID value, that is, a Base_PCR_PID_PID value.

Third, although a base time axis is defined based on the Base_PCR_PID value, a difference value between a PCR value of the first image and a PCR value of the second image needs to be set in order to make time values (e.g., time stamps) of the frames of the first image and the second image identical with each other. That is, assuming that the difference value is a PCR_offset value, the PCR_offset value needs to be transmitted to a reception terminal in order to compensate for a difference in the time axis between the PCR of the first image and the PCR of the second image. Furthermore, the PCR can include PCR_base and PCR_extension, and a PCR_base_offset value and a PCR_extension_offset value can be transmitted to the reception terminal. The PCR_base and the PCR_extension can have different clock frequencies. For example, the PCR_base can be represented in unit of 90 khz, and the PCR_extension can be represented in unit of 27 Mhz. The reception terminal can correct a Decoding Time Stamp (DTS), indicating a point of time for decoding by each ES, and a Presentation Time Stamp (PTS), indicating a point of time for representing (or playing) a decoded image, using the PCR_offset values (i.e., PCR_base_offset and PCR_extension_offset).

A descriptor capable of transmitting related information by incorporating the above items into the descriptor can be called a base PCR descriptor. The base PCR descriptor can be transmitted to a reception terminal through at least one of a first image TS and a second image TS. The base PCR descriptor can be configured as follows.

TABLE 2

| SYNTAX | NUMBER OF BITS | FORMAT |
|---|---|---|
| Base_PCR_descriptor( ){ | | |
| descriptor_tag | 8 | uimsbf |
| descriptor_length | 8 | uimsbf |
| Base_transport_stream_id | 16 | uimsbf |
| Base_program_number | 16 | uimsbf |
| reserved | 3 | bslbf |
| Base_PCR_PID | 13 | uimsbf |
| reserved | 7 | bslbf |
| PCR_base_offset | 33 | uimsbf |
| reserved | 7 | bslbf |
| PCR_extension_offset | 9 | uimsbf |
| } | | |

Referring to Table 2, the descriptor_tag field indicates the type of descriptor and can have a length of 8 bits. The descriptor_length field indicates the length of a descriptor and can have a length of 8 bits. The Base_transport_stream_id field couples two TSs (e.g., a first image TS and a second image TS) transmitted through a plurality of channels and can have a length of 16 bits. Particularly, the Base_transport_stream_id field indicates a transport_stream_id value included in the PAT of a TS to which a TS including a corresponding descriptor needs to refer. That is, the Base_transport_stream_id field can be said to indicate a base stream. The base stream can mean a stream including a base PCR, that is, a reference time value for synchronizing a first image and a second image. The base stream can be a TS including a base PCR descriptor or can be a TS transmitted in a channel different from a channel in which a TS including a base PCR descriptor is transmitted. For example, if a base PCR descriptor is included in a first image TS and a second image TS is a base stream, a value of the transport_stream_id field included in the PAT of the second image TS is identical with a value of the Base_transport_stream_id field included in the base PCR descriptor. For another example, if a base PCR descriptor is included in a first image TS and the first image TS is a base stream, a value of the transport_stream_id field included in the PAT of the first image TS is identical with a value of the Base_transport_stream_id field.

The Base_program_number field couples programs included in two TSs (e.g., a first image TS and a second image TS) transmitted through a plurality of channels and can have a length of 16 bits. The Base_program_number field indicates a program_number value included in the PMT of a TS to which a TS including a base PCR descriptor needs to refer. For example, if a base PCR descriptor is included in a first image TS and a second image TS is a base stream, a program_number field value is identical with a value of the Base_program_number field in the PMT of the second image TS.

The Base_PCR_PID field defines a value of a PCR that is a base time axis that needs to be used by two TSs (e.g., a first image TS and a second image TS) transmitted through a plurality of channels, a base PCR. The Base_PCR_PID field can have a length of 13 bits. In other words, the Base_PCR_PID field indicates a PCR_PID value of a TS in which a base PCR is transmitted. A PCR_PID value of a TS in which a base PCR that needs to be used as a base time axis by a TS including a base PCR descriptor and a TS coupled through a value of the Base_transport_stream_id field a value of the Base_program_number field is transmitted can be checked based on the Base_PCR_PID field. For example, the Base_PCR_PID field can indicate a PCR_PID value of a first image TS or a PCR_PID value of a second image TS. A reception terminal can analyze (or obtain) a base PCR value based on the Base_PCR_PID field.

The PCR_base_offset field indicates a difference value between PCR_base values of two TSs transmitted through transmitted through a plurality of channels and can have a length of 33 bits. The PCR_base_offset field can be used to make time values (e.g., time stamps) of the respective frames of a first image and a second image identical with each other.

The PCR_extension_offset field indicates a difference value between PCR_extension values of two TSs transmitted through a plurality of channels and can have a length of 9 bits. The PCR_extension_offset field can be used to make time values of the respective frames of a first image and a second image identical with each other.

Referring back to FIG. 1, the apparatus for determining a base PCR selects a base stream from the plurality of streams, transmitted through the plurality of channels, based on the base PCR descriptor at step S120. The apparatus for determining a base PCR can select the base stream on the basis of the Base_transport_stream_id field and the Base_program_number field of the base PCR descriptor. Particularly, the apparatus for determining a base PCR can check an associated program based on a program_number value indicated by the Base_program_number field and select the base stream based on a transport_stream_id value indicated by the Base_transport_stream_id field.

The apparatus for determining a base PCR obtains (or determines) a base PCR for synchronizing multiple images (e.g., a first image and a second image) for the plurality of streams, which form realistic broadcasting service, based on the base PCR descriptor at step S140. Here, the realistic broadcasting service, as described above, can include broadcasting service based on multiple images, such as 3-D TV, UHDTV, and panorama broadcasting service. The apparatus for determining a base PCR can obtain (or determine) the base PCR based on the base stream and the Base_PCR_PID field. Particularly, the apparatus for determining a base PCR can interpret a PID indicated by the Base_PCR_PID in the base stream indicated by the Base_transport_stream_id field and obtain the base PCR.

The apparatus for determining a base PCR synchronizes multiple images that form the realistic broadcasting service based on the base PCR at step S160. The apparatus for determining a base PCR can decode the plurality of streams received through the plurality of channels and obtain multiple images that form the realistic broadcasting service. Furthermore, the apparatus for determining a base PCR can make time values of the respective frames of the multiple images identical with each other based on the PCR_base_offset field and the PCR_extension_offset field when synchronizing the multiple images based on the base PCR.

The apparatus for determining a base PCR can determine (or analyze) the base PCR in the base stream as described above, synchronize the multiple images (e.g., a first image and a second image) that form the realistic broadcasting service, and smoothly provide 3-D TV, UHDTV, or panorama broadcasting service through the plurality of channels based on the synchronized multiple images.

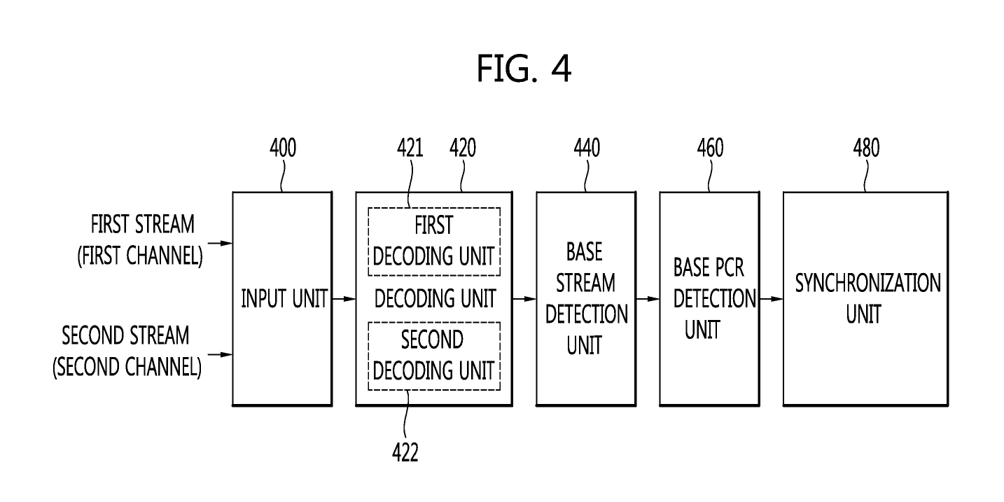

FIG. 4 is a block diagram of the apparatus for determining a base PCR in multiple images for realistic broadcasting service in accordance with an embodiment of the present invention.

Referring to FIG. 4, the apparatus for determining a base PCR includes an input unit 400, a decoding unit 420, a base stream detection unit 440, and a base PCR detection unit 460. The apparatus for determining a base PCR can further include a synchronization unit 480.

The input unit 400 receives data regarding multiple images for realistic broadcasting service from the outside (e.g., the transmission unit of a transmission terminal). Particularly, the input unit 400 can receive a plurality of streams (e.g., a first stream and a second stream) regarding the multiple images. The plurality of streams is transmitted through a plurality of channels (e.g., a first channel and a second channel). The input unit 400 may directly receive the streams through the plurality of channels or may receive the streams through an additional reception apparatus.

The decoding unit 420 decodes the streams and obtains the multiple images for the realistic broadcasting service. The decoding unit 420 obtains a PMT and a PAT based on the streams. Furthermore, the decoding unit 420 further obtains a base PCR descriptor based on at least one of the streams. The decoding unit 420 can include a first decoding unit 421 and a second decoding unit 422. In this case, the first decoding unit 421 can decode a stream regarding a first stream, from among the multiple images, and the second decoding unit 422 can decode a stream regarding a second stream, from among the multiple images. At least one of the first decoding unit 421 and the second decoding unit 422 further obtains the base PCR descriptor.

The base stream detection unit 440 selects (or detects) a base stream based on the base PCR descriptor. The base stream detection unit 440 can select the base stream based on the Base_transport_stream_id field and the Base_program_number field of the base PCR descriptor. Particularly, the base stream detection unit 440 can check an associated program based on a program_number value indicated by the Base_program_number field and select the base stream based on a transport_stream_id value indicated by the Base_transport_stream_id field.

The base PCR detection unit 460 obtains (or detects) a base PCR based on the base PCR descriptor. The PCR detection unit 460 can obtain (or detect) the base PCR based on the Base_PCR_PID field included in the base PCR descriptor. Particularly, the apparatus for determining a base PCR can interpret a PID indicated by the Base_PCR_PID in the base stream indicated by the Base_transport_stream_id field and obtain the base PCR.

The synchronization unit 480 synchronizes the multiple images (i.e. the first image and the second image) that form the realistic broadcasting service based on the base PCR at step S160. The synchronization unit 480 can synchronize the multiple images, decoded by the decoding unit 420, based on the base PCR. Furthermore, the synchronization unit 480 can make time values of the respective frames of the multiple images identical with each other based on the PCR_base_offset field and the PCR_extension_offset field included in the base PCR descriptor when synchronizing the multiple images based on the base PCR.

As described above, in accordance with the present invention, in providing realistic broadcasting service, such as 3-D TV, UHDTV, and panorama broadcasting service, a base stream can be searched for in a plurality of streams received through a plurality of channels, a base PCR can be analyzed (or obtained) in the base stream, and multiple images that form the realistic broadcasting service can be synchronized and provided to a viewer.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A method of synchronizing a first image and a second image forming multiple images in broadcasting service based on the multiple images, the method comprising:
receiving a stream regarding the first stream and a stream regarding the second stream through a plurality of channels;
obtaining the first image and the second image by decoding the stream regarding the first stream and the stream regarding the second stream and obtaining a base Program Clock Reference (PCR) descriptor in at least one of the stream regarding the first stream and the stream regarding the second stream;
selecting a base stream based on the base PCR descriptor and determining a base PCR based on the base PCR descriptor; and
synchronizing the first image and the second image based on the base PCR.

2. The method of claim 1, wherein the base PCR descriptor comprises at least one of a descriptor_tag field indicative of a type of the descriptor, a descriptor_length field indicative of a length of the descriptor, a Base_transport_steam_id field indicative of an ID value of a transport stream to be referred to, a Base_program_number field indicative of a program to be referred to, and a Base_PCR_PID field indicative of a base time axis.

3. The method of claim 2, wherein the base stream is selected based on the Base_transport_stream_id field.

4. The method of claim 3, wherein the base stream is selected based on the Base_program_number field.

5. The method of claim 4, wherein the base PCR is determined based on the Base_PCR_PID field.

6. The method of claim 5, wherein the base PCR is determined based on the selected base stream and a Packet Identifier (PID) indicated by the Base_PCR_PID field.

7. The method of claim 2, wherein the base PCR descriptor further comprises a PCR_base_offset field and a PCR_extension_offset field for compensating for a difference a PCR of the first image and a PCR of the second image in a time axis.

8. The method of claim 7, wherein the synchronization is performed after time values of respective frames of the first image and the second image are made identical with each other based on the PCR_base_offset field and the PCR_extension_offset field.

9. A method of transmitting a first image and a second image forming multiple images in broadcasting service based on the multiple images, the method comprising:
including a base Program Clock Reference (PCR) descriptor in at least one of a stream regarding the first stream and a stream regarding the second stream and sending the streams to a reception terminal,
wherein the base PCR descriptor comprises at least one of a descriptor_tag field indicative of a type of the descriptor, a descriptor_length field indicative of a length of the descriptor, a Base_transport_steam_id field indicative of an ID value of a transport stream to be referred to, a Base_program_number field indicative of a program to be referred to, and a Base_PCR_PID field indicative of a base time axis.

10. The method of claim 9, wherein the base PCR descriptor further comprises a PCR_base_offset field and a PCR_extension_offset field for compensating for a difference a PCR of the first image and a PCR of the second image in a time axis.

11. An apparatus for determining a base Program Clock Reference (PCR) for synchronizing a first image and a second image forming multiple images in broadcasting service based on the multiple images, the apparatus comprising:
an input unit for receiving a stream regarding the first stream and a stream regarding the second stream through a plurality of channels;
a decoding unit for obtaining the first image and the second image by decoding the stream regarding the first stream and the stream regarding the second stream and obtaining a base PCR descriptor in at least one of the stream regarding the first stream and the stream regarding the second stream;
a base stream detection unit for detecting a base stream based on the base PCR descriptor;
a base PCR detection unit for determining a base PCR based on the base PCR descriptor; and
a synchronization unit for synchronizing the first image and the second image based on the base PCR.

12. The apparatus of claim 11, wherein the input unit receives the base PCR descriptor comprising at least one of a descriptor_tag field indicative of a type of the descriptor, a descriptor_length field indicative of a length of the descriptor, a Base_transport_steam_id field indicative of an ID value of a transport stream to be referred to, a Base_program_number field indicative of a program to be referred to, and a Base_PCR_PID field indicative of a base time axis.

13. The apparatus of claim 12, wherein the base stream detection unit detects the base stream based on the Base_transport_stream_id field included in the base PCR descriptor.

14. The apparatus of claim 13, wherein the base stream detection unit detects the base stream based on the Base_program_number field included in the base PCR descriptor.

15. The apparatus of claim 14, wherein the base PCR detection unit detects the base PCR based on the Base_PCR_PID field included in the base PCR descriptor.

16. The apparatus of claim 15, wherein the base PCR detection unit detects the base PCR based on the selected base stream and a Packet Identifier (PID) indicated by the Base_PCR_PID field.

17. The apparatus of claim 12, wherein the input unit receives the base PCR descriptor further comprising a PCR_base_offset field and a PCR_extension_offset field for compensating for a difference a PCR of the first image and a PCR of the second image in a time axis.

18. The apparatus of claim 17, wherein the synchronization unit synchronizes the first image and the second image after making time values of respective frames of the first image and the second image identical with each other based on the PCR_base_offset field and the PCR_extension_offset field.
